(19) United States
(12) Patent Application Publication
(10) Pub. No.: US 2025/0087941 A1
(43) Pub. Date: Mar. 13, 2025

(54) PLUG ASSEMBLY

(71) Applicant: Anker Innovations Technology Co., Ltd., Changsha (CN)

(72) Inventors: Jianjun HUANG, Shenzhen (CN); Jing QIAN, Shenzhen (CN)

(21) Appl. No.: 18/958,106

(22) Filed: Nov. 25, 2024

Related U.S. Application Data
(63) Continuation of application No. PCT/CN2023/090014, filed on Apr. 23, 2023.

(30) Foreign Application Priority Data
May 25, 2022 (CN) 202221274171.X

(51) Int. Cl. H01R 13/20; H01R 13/639; H01R 24/68; H01R 103/00

(52) U.S. Cl. CPC H01R 13/20; H01R 13/639; H01R 24/68; H01R 2103/00

(57) ABSTRACT

A plug assembly is disclosed. The plug assembly comprises a plug comprising a plug body and pins arranged at one end of the plug body; and a suction cup sleeved on a peripheral surface of the end of the plug body. The suction cup may be configured to abut against a socket when the plug is plugged into the socket.

### CROSS-REFERENCE TO RELATED APPLICATIONS

The present application is a continuation of and claims priority to PCT/CN2023/090014, filed on Apr. 23, 2023, which claims priority to Chinese Patent Application No. 202221274171X filed with the China Patent Office on May 25, 2022 and entitled “ANTI-DROP DEVICE AND PLUG ASSEMBLY,” each of which is incorporated herein by reference in its entirety.

### TECHNICAL FIELD

The present application relates to the technical field of electrical accessories, in particular to a plug assembly.

### BACKGROUND

With the development of the times, the power of chargers is increasing, and the weight of corresponding charger plugs is also increasing. Even when a charger is plugged into a high-quality wall socket for charging, the charger has the risks of tilting and dropping. In related technical fields, when some wall sockets with poor quality or excessively long service time are used for charging chargers, charger pins may not be held by wall socket springs firmly, resulting in charger tilting or dropping from the wall sockets.

### SUMMARY

The present application describes a plug assembly, which can strengthen the stability of connection between a plug and a socket to reduce the probability of drop of the plug from the socket.

In a first aspect, the present application provides an anti-drop device (e.g., a suction cup, elastic sleeve) used for matching a plug. The plug comprises a plug body and pins connected to the plug body. The anti-drop device can be at least sleeved on a peripheral surface of the end of the plug body close to the pins, and the anti-drop device can abut against a socket when the plug is plugged into the socket.

Based on the anti-drop device in the examples of the present application, when the plug is plugged into the socket, the plug is subjected to its gravity, the pins of the plug are subjected to frictional force of plugging into the socket, and the point where the contact surface between the plug and the socket is farthest from the pins and is located below the pins is a torque point, where the gravity of the plug will produce a torque that enables the plug to have a tendency to drop from the socket, and the direction of a torque produced by the frictional force between the plug and the socket is opposite to that of the torque produced by the plug, which will prevent the plug from dropping from the socket.

The anti-drop device may be sleeved on the peripheral surface of the end of the plug body close to the pins, and the anti-drop device can abut against the socket when the plug is plugged into the socket, so the distance between the centroid of the plug and the contour line of the contact surface between the anti-drop device and the socket is greater than that between the centroid of the plug and the contour line of the contact surface between the plug body and the socket. In this case, a new torque point produced by the plug and the anti-drop device as a whole moves downwards compared to the torque point between the plug and the socket. According to a force calculation formula M=1f, a position vector of the gravity of the plug from the new torque point remains unchanged (e.g., the magnitude and direction of the torque produced by the weight of plug do not change), while a position vector of the frictional force between the plug and the socket from the new torque point increases (e.g., the magnitude of the torque produced by the frictional force between the plug and the socket increases but its direction does not change), thereby reducing the probability of drop of the plug from the socket and strengthening the stability of connection between the plug and the socket.

In some examples of the present application, when the plug is plugged into the socket, the anti-drop device for the plug abuts against the socket in a negative pressure suction manner.

Based on the above examples, the anti-drop device for the plug abuts against the socket in a negative pressure suction manner, and the direction of suction force between the anti-drop device and the socket is the same as that of the frictional force between the plug and the socket. Meanwhile, the new torque point produced by the plug and the anti-drop device as a whole moves downwards compared to the torque point between the plug and the socket. Then, the torque produced by the suction force may prevent the plug from dropping from the socket, and the torque produced by the frictional force between the plug and the socket increases, thereby further strengthening the stability of connection between the anti-drop device and the socket and reducing the probability of drop of the plug from the socket.

In some examples of the present application, the entire anti-drop device may be a suction cup, and the anti-drop device is sucked to the socket when the plug is plugged into the socket; or the anti-drop device may be an elastic sleeve, the surface of the anti-drop device for abutting against the socket has a plurality of suction grooves, and the anti-drop device is sucked to the socket through the plurality of suction grooves.

Based on the above examples, the entire anti-drop device may be a suction cup, so that the anti-drop device can be directly sucked to the socket when the plug is plugged into the socket, to strengthen the stability of connection between the anti-drop device and the socket and further reduce the probability of drop of the plug from the socket.

The anti-drop device may be an elastic sleeve. When the elastic sleeve abuts against and presses the socket, the elastic sleeve deforms to discharge air in the suction grooves, so that the elastic sleeve is sucked to the socket, to strengthen the stability of connection between the anti-drop device and the socket and further reduce the probability of drop of the plug from the socket.

In some examples of the present application, the anti-drop device comprises: a sleeve at least sleeved on the peripheral surface of the end of the plug body close to the pins; and a suction device connected to the sleeve, wherein when the plug is plugged into the socket, the suction device is sucked to the socket, and the sleeve abuts against the socket or is spaced apart from the socket.

Based on the above examples, after the plug is plugged into the socket, the suction device is sucked to the socket. In this case, the torque produced by the suction force between the suction device and the socket is in the same direction as the frictional force between the plug and the socket. Meanwhile, the new torque point produced by the plug and the anti-drop device as a whole moves downwards compared to the torque point between the plug and the socket. Then, the torque produced by the suction force will prevent the plug from dropping from the socket, and the torque produced by the frictional force between the plug and the socket increases. Therefore, the torque produced by the suction force between the suction device and the socket prevents the plug from dropping from the socket, thereby reducing the probability of drop of the plug from the socket.

After the plug is plugged into the socket, the suction device is sucked to the socket and the sleeve abuts against the socket. In this case, the torque produced by the suction force between the suction device and the socket is in the same direction as the frictional force between the plug and the socket, and the sleeve increases the distance between the new torque point and the frictional force between the plug and the socket (compared to the distance between the new torque point and the frictional force between the plug and the socket when the suction device is sucked to the socket and the sleeve abuts against the socket), whereby the torque produced by the suction force between the suction device and the socket may prevent the plug from dropping from the socket, and the new torque point produced by the plug and the anti-drop device as a whole moves downwards compared to the torque point between the plug and the socket. Therefore, the torque produced by the suction force may prevent the plug from dropping from the socket, the torque produced by the frictional force between the plug and the socket increases, and the probability of drop of the plug from the socket is reduced.

In some examples of the present application, the socket has a first opposite surface matching the socket, the first opposite surface has a receiving groove, the suction device is partially arranged in the receiving groove and connected to a groove wall of the receiving groove, and the suction device can deform and at least partially retract into the receiving groove when being sucked to the socket.

Based on the above examples, the sleeve is provided with the receiving groove on the first opposite surface, the suction device is partially arranged in the receiving groove, and the suction device deforms and at least partially retracts into the receiving groove after the plug is plugged into the socket. If the suction device partially retracts into the receiving groove, a new torque point is formed between the suction device and the socket. If the suction device completely retracts into the receiving groove, the first opposite surface of the sleeve can abut against the socket, and a new torque point is formed between the receiving groove and the socket.

In some examples of the present application, a plurality of suction devices are distributed along the circumference of the sleeve, and the plurality of suction devices surround the pins when the sleeve is sleeved on the plug body.

Based on the above examples, the plurality of suction devices strengthen the stability of the connection between the anti-drop device and the socket, which further reduces the probability of drop of the plug from the socket.

In some examples of the present application, the anti-drop device comprises: a hard shell arranged in a ring shape; and an elastic lining arranged inside the hard shell and capable of elastic deformation to be sleeved on the peripheral surface of the end of the plug body close to the pins.

Based on the above examples, the hard shell facilitates a user to sleeve the anti-drop device onto the plug body, and the elastic lining facilitates the matching between the anti-drop device and the plug body. After the plug is plugged into the elastic lining, the elastic force produced by the elastic recovery deformation of the elastic lining can enhance the frictional force between the anti-drop device and the plug body, thereby strengthening the stability of connection between the anti-drop device and the plug body. In addition, the elastic lining can deform to some extent, so that the anti-drop device is applicable to plug bodies of different sizes, which enhances the applicability of the anti-drop device.

In some examples of the present application, the anti-drop device has a first opposite surface matching the socket, the plug has a second opposite surface for abutting against the socket, and after the anti-drop device is sleeved on the plug body, the distance between the first opposite surface and the second opposite surface in the plugging direction of the plug is greater than or equal to 0 mm and less than or equal to 10 mm.

Based on the above examples, within this range, even if the anti-drop device has enough space for deformation, when the anti-drop device is a suction cup or is provided with a suction cavity, the air in the suction cup or suction cavity can be discharged, which can ensure that the anti-drop device can be sucked onto the socket after deformation, and can prevent the second opposite surface from not being able to abut against the socket after the anti-drop device deforms.

In a second aspect, the examples of the present application provide a plug assembly, comprising: a plug, including a plug body and pins arranged at one end of the plug body; and the anti-drop device as described above, where the anti-drop device can be sleeved on a peripheral surface of the end of the plug body close to the pins.

Based on the above examples, after the plug is plugged into the socket, the plug and the anti-drop device are regarded as a whole, where the anti-drop device can increase the torque produced by the frictional force between the plug and the socket, thereby reducing the probability of drop of the plug from the socket and strengthening the stability of connection between the plug and the socket.

In some examples of the present application, the end of the plug body close to the pins has a first limiting structure, the inner surface of the anti-drop device has a second limiting structure, and after the anti-drop device is sleeved on the plug body, the first limiting structure and the second limiting structure limit each other, so that the anti-drop device is in interference fit with the plug body, and the anti-drop device can only be detached from the plug body in the plugging direction of the plug.

Based on the above examples, after the plug body is connected to the anti-drop device, the first limiting structure and the second limiting structure limit each other to position the plug body in the anti-drop device. Because the anti-drop device can only be detached from the plug body in the plugging direction of the plug, and the user applies a thrust force to the plug when plugging the plug into the socket, the plug can transmit the thrust force to the anti-drop device, whereby the anti-drop device abuts against or is sucked to the socket. During disassembly, only the plug is removed, and the anti-drop device may be always connected to the socket, thereby reducing the number of deformations of the anti-drop device and prolonging the service life of the anti-drop device.

Based on the anti-drop device in the examples of the present application, when the plug is plugged into the socket, the plug is subjected to its gravity, the pins of the plug are subjected to frictional force of plugging into the socket, and the point where the contact surface between the plug and the socket is farthest from the pins and is located below the pins is a torque point, where the gravity of the plug may produce a torque that enables the plug to have a tendency to drop from the socket, and the direction of a torque produced by the frictional force between the plug and the socket is opposite to that of the torque produced by the plug, which may prevent the plug from dropping from the socket. The anti-drop device is sleeved on the peripheral surface of the end of the plug body close to the pins, and the anti-drop device can abut against the socket when the plug is plugged into the socket, so the distance between the centroid of the plug and the contour line of the contact surface between the anti-drop device and the socket is greater than that between the centroid of the plug and the contour line of the contact surface between the plug body and the socket. In this case, a new torque point produced by the plug and the anti-drop device as a whole moves downwards compared to the torque point between the plug and the socket. According to M=1f, a position vector of the gravity of the plug from the new torque point remains unchanged. The magnitude and direction of the torque produced by the weight of plug may not change, while a position vector of the frictional force between the plug and the socket from the new torque point increases (e.g., the magnitude of the torque produced by the frictional force between the plug and the socket increases but its direction does not change, thereby reducing the probability of drop of the plug from the socket and strengthening the stability of connection between the plug and the socket).

### BRIEF DESCRIPTION OF THE DRAWINGS

To describe the technical solutions in the examples of the present application or in the prior art more clearly, the following briefly introduces the accompanying drawings required for describing the examples or the prior art. Apparently, the accompanying drawings in the following description show only some examples of the present application, and those of ordinary skill in the art can derive other drawings from the accompanying drawings without any creative efforts.

FIG. 1 is a schematic structural diagram of an anti-drop device sleeved on a plug in an example of the present application;

FIG. 2 is a force analysis diagram of the anti-drop device, plug, and socket connected in the present application;

FIG. 3 is a schematic structural diagram of an anti-drop device in another example of the present application; and

FIG. 4 is an exploded view of the structure in FIG. 1 taken along an A-A section.

Reference numerals: 10. Anti-drop device; 11. Suction groove; 12. Sleeve; 121. First opposite surface; 122. Receiving groove; 13. Sucker; 14. Hard shell; 15. Elastic lining; 16. Second limiting structure; 20. Plug; 21. Plug body; 211. First limiting structure; 212. Second opposite surface; 22. Pin; 30. Socket; a. Plugging direction of the plug.

### DETAILED DESCRIPTION

In order to make the objectives, technical solutions, and advantages of the present application clearer, the following further describes the present application in detail in conjunction with the accompanying drawings and examples. It should be understood that the specific examples described herein are merely used for explaining the present application, but are not used for limiting the present application.

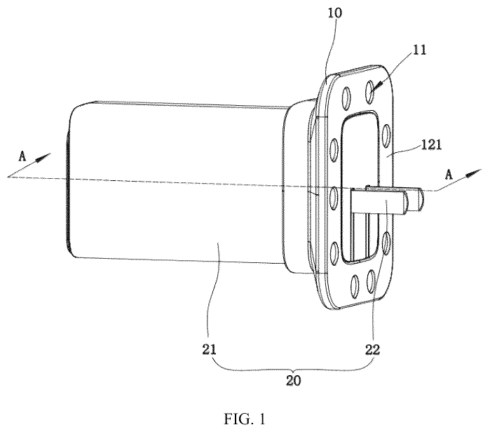

In order to solve the above technical problems, with reference to FIGS. 1-4, a first aspect of the present application provides an anti-drop device 10, which can strengthen the stability of connection between a plug 20 and a socket 30 (e.g., a wall socket), to reduce the probability of drop of the plug 20 from the socket 30. The socket 30 may be a wall socket as an example for description herein. It can be understood that the socket 30 matching the plug 20 may be any type of socket 30.

In the first aspect, with reference to FIG. 1 to FIG. 3, the present application describes an anti-drop device 10 used for matching a plug 20. The plug 20 may comprise a plug body 21 and pins 22 connected to the plug body 21, and the anti-drop device 10 can be at least sleeved on a peripheral surface of the end of the plug body 21 close to the pins 22. The anti-drop device 10 can be entirely sleeved on the peripheral surface of the plug body 21. When the plug 20 is plugged into the socket 30, the anti-drop device 10 can abut against the socket 30.

The plug 20 in the examples of the present application may be a dual-pin plug, a three-pin plug, an ordinary plug, or an explosion-proof plug, which is not limited herein. As long as the plug 20 needs to match any external device such as a wall socket, the plug can be applied to the anti-drop device 10. For example, when the plug 20 is plugged into the socket 30, the anti-drop device 10 abuts against the socket 30; or when the plug 20 is plugged into an electrical device, the anti-drop device 10 abuts against a housing of the electrical device. The anti-drop device 10 in the examples of the present application can reduce the probability of drop of the plug 20 from the socket 30 or the electrical device.

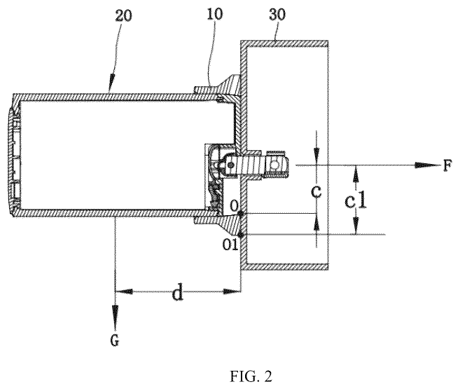

As shown in at least FIG. 2, when the plug 20 is plugged into the socket 30 such as a wall socket, the plug 20 is subjected to its gravity G, the pins 22 of the plug 20 are subjected to frictional force F of plugging into the socket 30, and the point where the contact surface between the plug 20 and the socket 30 is farthest from the pins 22 and is located below the pins 22 is a torque point, where the gravity G of the plug 20 may produce a torque that enables the plug 20 to have a tendency to drop from the socket 30, and the direction of a torque produced by the frictional force F between the plug 20 and the socket 30 may be opposite to that of the torque produced by the plug 20, which may prevent the plug 20 from dropping from the socket 30.

The anti-drop device 10 can be sleeved on the peripheral surface of the end of the plug body 21 close to the pins 22, and the anti-drop device 10 can abut against the socket 30 when the plug 20 is plugged into the socket 30, so the distance between the centroid of the plug 20 and the contour line of the contact surface between the anti-drop device 10 and the socket 30 is greater than that between the centroid of the plug 20 and the contour line of the contact surface between the plug body 21 and the socket 30. In this case, a new torque point produced by the plug 20 and the anti-drop device 10 as a whole moves downwards compared to the torque point between the plug 20 and the socket 30 without the anti-drop device 10. According to M=1f (where M is a torque; 1 is a position vector from a force to a torque point; f is a magnitude direction of the force), a position vector of the gravity of the plug 20 from the new torque point remains unchanged (e.g., the magnitude and direction of the torque produced by the weight of plug 20 do not change, while a position vector of the frictional force between the plug 20 and the socket 30 from the new torque point increases). The magnitude of the torque produced by the frictional force between the plug 20 and the socket 30 increases but its direction does not change, thereby reducing the probability of drop of the plug 20 from the socket 30 and strengthening the stability of connection between the plug 20 and the socket 30. Specifically, with reference to FIG. 2, O is a torque point between the plug 20 and the socket 30, O1 is a torque point between the anti-drop device 10 and the socket 30, d is a position vector of the gravity of the socket 30 from the torque point O1, c is a position vector of the frictional force between the plug 20 and the socket 30 from the torque point O, c1 is a position vector of the frictional force between the plug 20 and the socket 30 from the torque point O1, G is the weight of the plug, and F is the frictional force between the plug and the socket 30. It can be clearly concluded that the distances between the gravitational force acting on the socket 30 and the torque points O and O1 are d (e.g., the torque produced by gravity is the same sequentially based on O and O1); c1 m greater than c. After the anti-drop device 10 is sleeved outside the socket 30, the torque produced by the frictional force between the plug 20 and the socket 30 increases. The direction of the torque produced by the frictional force F between the plug and the socket 30 is opposite to that of the torque produced by the gravity G of the socket 30, where the torque produced by the gravity G of the plug enables the socket 30 to have a tendency to rotate counterclockwise (refer to FIG. 2) around point O1. The plug may have a tendency to drop from the socket 30, and the torque produced by the frictional force F between the plug and the socket 30 enables the socket 30 to have a tendency to rotate clockwise (refer to FIG. 2) around point O1 (e.g., there is a tendency to prevent the plug from dropping from the socket 30, so the anti-drop device strengthens the stability of connection between the plug 20 and the socket 30).

In some examples of the present application, when the plug 20 is plugged into the socket 30, the anti-drop device for the plug 20 abuts against the socket 30 in a negative pressure suction manner.

Through the above technical solution, the anti-drop device 10 for the plug 20 abuts against the socket 30 in a negative pressure suction manner, and the direction of suction force between the anti-drop device 10 and the socket 30 is the same as that of the frictional force between the plug 20 and the socket 30. Meanwhile, the new torque point produced by the plug 20 and the anti-drop device 10 as a whole moves downwards compared to the torque point between the plug 20 and the socket 30. Then, the torque produced by the suction force may prevent the plug 20 from dropping from the socket 30, and the torque produced by the frictional force between the plug 20 and the socket 30 increases, thereby further strengthening the stability of connection between the anti-drop device 10 and the socket 30 and reducing the probability of drop of the plug 20 from the socket 30.

In order to suck the anti-drop device 10 onto the socket 30, in some examples of the present application, the entire anti-drop device 10 is a suction cup, and the anti-drop device 10 is sucked to the socket 30 when the plug 20 is plugged into the socket 30 The anti-drop device 10 can be directly sucked to the socket 30 when the plug 20 is plugged into the socket 30, to strengthen the stability of connection between the anti-drop device 10 and the socket 30 and further reduce the probability of drop of the plug 20 from the socket 30.

In order to suck the anti-drop device 10 onto the socket 30, with reference to FIG. 1, in some examples of the present application, the anti-drop device 10 may be an elastic sleeve, the surface of the anti-drop device 10 for abutting against the socket 30 may have a plurality of suction grooves 11, and the anti-drop device 10 may be sucked to the socket 30 through the plurality of suction grooves 11.

Through the above technical solution, when the elastic sleeve abuts against and presses the socket 30, the elastic sleeve deforms to discharge air in the suction grooves 11, so that the elastic sleeve is sucked to the socket 30, to strengthen the stability of connection between the anti-drop device 10 and the socket 30 and further reduce the probability of drop of the plug 20 from the socket 30. The shape, size, and material of the elastic sleeve and the suction grooves 11 are not limited in the examples of the present application. In some examples of the present application, the suction grooves 11 may be cylindrical cavities. In other examples of the present application, the suction grooves 11 may be horn cavities. For the material of the elastic sleeve, in some examples of the present application, the elastic sleeve is made of rubber. In other examples of the present application, the elastic sleeve is made of silicone.

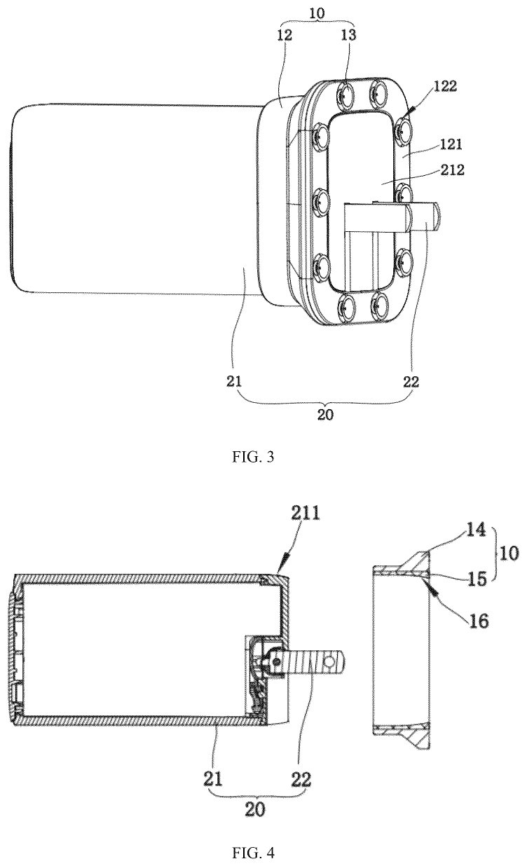

In order to suck the anti-drop device 10 onto the socket 30, with reference to FIG. 3, in yet other examples of the present application, the anti-drop device 10 may comprise a sleeve 12 and a suction device 13 (e.g., a sucker), where the sleeve 12 is at least sleeved on the peripheral surface of the end of the plug body 21 close to the pins 22; the suction device 13 is connected to the sleeve 12, and when the plug 20 is plugged into the socket 30, the suction device 13 is sucked to the socket 30, and the sleeve 12 is spaced apart from the socket 30.

The sleeve 12 is used for sleeving the body of the plug 20 and abutting against the socket 30 when the plug 20 is plugged into the socket 30. The material, shape, and size of the sleeve 12 are not limited in the examples of the present application, as long as the sleeve 12 can be sleeved with the body of the plug 20 and abut against the socket 30 when the plug 20 is plugged into the socket 30. For the material of the sleeve 12, because the suction device 13 is sucked to the socket 30, in some examples of the present application, the sleeve 12 is made of a rigid material. In other examples of the present application, the sleeve 12 is partially made of a rigid material and partially made of an elastic material. The suction device 13 is connected to the rigid portion of the sleeve 12 to facilitate deformation of the suction device 13 when external force is applied to the sleeve 12 (e.g., the suction device 13 is sucked to the socket 30 more easily).

The suction device 13 is used for being sucked to the socket 30 when the plug 20 is plugged into the socket 30. In some examples of the present application. The suction device 13 may be a suction cup. In other examples of the present application, the suction device 13 may be a magnetic suction device, and the magnetic force produced by the magnetic suction device can produce magnetic suction force on a magnetic body inside the socket 30, or a magnetic body, such as an iron, cobalt, nickel product or magnet, is arranged inside the socket 30, which is not limited by the examples of the present application.

Based on the above examples, after the plug 20 is plugged into the socket 30, the suction device 13 is sucked to the socket 30. In this case, the torque produced by the suction force between the suction device 13 and the socket 30 is in the same direction as the frictional force between the plug 20 and the socket 30. Meanwhile, the new torque point produced by the plug 20 and the anti-drop device 10 as a whole moves downwards compared to the torque point between the plug 20 and the socket 30. Then, the torque produced by the suction force may prevent the plug 20 from dropping from the socket 30, and the torque produced by the frictional force between the plug 20 and the socket 30 increases. Therefore, the torque produced by the suction force between the suction device 13 and the socket 30 prevents the plug 20 from dropping from the socket 30, thereby reducing the probability of drop of the plug 20 from the socket 30.

In other examples of the present application, the sleeve 12 abuts against the socket 30 when the plug 20 is plugged into the socket 30. In this case, the torque produced by the suction force between the suction device 13 and the socket 30 is in the same direction as the frictional force between the plug 20 and the socket 30, and the sleeve 12 increases the distance between the new torque point and the frictional force between the plug 20 and the socket 30 (compared to the distance between the new torque point and the frictional force between the plug 20 and the socket 30 when the suction device 13 is sucked to the socket 30 and the sleeve 12 abuts against the socket 30), whereby the torque produced by the suction force between the suction device 13 and the socket 30 may prevent the plug 20 from dropping from the socket 30, and the new torque point produced by the plug 20 and the anti-drop device 10 as a whole moves downwards compared to the torque point between the plug 20 and the socket 30. Therefore, the torque produced by the suction force may prevent the plug 20 from dropping from the socket 30, the torque produced by the frictional force between the plug 20 and the socket 30 increases, and the probability of drop of the plug 20 from the socket 30 is reduced.

With reference to FIG. 3, in some examples of the present application, the sleeve 12 has a first opposite surface 121 matching the socket 30, the first opposite surface 121 has a receiving groove 122, the suction device 13 is partially arranged in the receiving groove 122 and connected to a groove wall of the receiving groove 122, and the suction device 13 can deform and at least partially retract into the receiving groove 122 when being sucked to the socket 30.

Based on the above examples, the sleeve 12 is provided with the receiving groove 122 on the first opposite surface 121, the suction device 13 is partially arranged in the receiving groove 122, and the suction device 13 deforms and at least partially retracts into the receiving groove 122 after the plug 20 is plugged into the socket 30. If the suction device 13 partially retracts into the receiving groove 122, a new torque point is formed between the suction device 13 and the socket 30. If the suction device 13 completely retracts into the receiving groove 122, the first opposite surface 121 of the sleeve 12 can abut against the socket 30, and a new torque point is formed between the receiving groove 122 and the socket 30.

With reference to FIG. 3, in some examples of the present application, a plurality of suction devices 13 are distributed along the circumference of the sleeve 12, and the plurality of suction devices 13 surround the pins 22 when the sleeve 12 is sleeved on the plug body 21. The plurality of suction devices 13 strengthen the stability of connection between the anti-drop device 10 and the socket 30 and further reduce the probability of drop of the plug 20 from the socket 30. Specifically, in some examples of the present application, the plurality of suction devices 13 are distributed at equal intervals along the circumference of the sleeve 12.

With reference to FIG. 4, in some examples of the present application, the anti-drop device 10 may comprise a hard shell 14 and an elastic lining 15, where the hard shell 14 is arranged in a ring shape. The elastic lining 15 may be arranged inside the hard shell in a ring shape and is capable of elastic deformation to be sleeved on the peripheral surface of the end of the plug body 21 close to the pins 22. It can be understood that the elastic lining 15 may be a plurality of spaced elastic portions for abutting against the peripheral surface of the body 21 of the socket 30.

The hard shell 14 facilitates a user to sleeve the anti-drop device 10 onto the plug body 21, even if the user takes the anti-drop device 10 and applies external force to the anti-drop device 10. The material, shape, and size of the hard shell 14 are not limited in the examples of the present application. For the material of the hard shell 14, in order to ensure user safety, in some examples of the present application, the hard shell 14 is made of an insulating material, such as hard plastic, hard silicone, or wooden material. For the shape of the hard shell 14, in order to reduce the material used for the hard shell 14, in some examples of the present application, the hard shell 14 includes a smooth portion and an enlarged portion connected to the smooth portion, and the outer diameter of the enlarged end gradually increases in the plugging direction of the plug 20. The size of the hard shell 14 should be set according to the sizes of the socket 30 and the plug 20.

The elastic lining 15 can deform, which facilitates the matching between the anti-drop device 10 and the plug body 21. After the plug 20 is plugged into the elastic lining 15, the elastic force produced by the elastic recovery deformation of the elastic lining 15 can enhance the frictional force between the anti-drop device 10 and the plug body 21, thereby strengthening the stability of connection between the anti-drop device 10 and the plug body 21. In addition, the elastic lining 15 can deform to some extent, so that the anti-drop device 10 is applicable to plug bodies 21 of different sizes, which enhances the applicability of the anti-drop device 10. In the examples of the present application, the material, shape, and size of the elastic lining 15 are not limited in the examples of the present application. For the material of the elastic lining 15, in some examples of the present application, the elastic lining 15 may be made of silicone. In other examples of the present application, the elastic lining 15 may be made of rubber.

With reference to FIG. 3, in some examples of the present application, the anti-drop device 10 comprises a first opposite surface 121 opposite to the socket 30, the plug 20 has a second opposite surface 212 opposite to the socket 30, and after the anti-drop device 10 is sleeved on the plug body 21, the distance between the first opposite surface 121 and the second opposite surface 212 in the plugging direction of the plug 20 is greater than or equal to 0 mm and less than or equal to 10 mm.

The first opposite surface 121 (which may be associated with the suction device 13) is used for abutting against the socket 30 when the plug 20 is plugged into the socket 30, to increase the distance between the new torque point and the frictional force between the plug 20 and the socket 30. When the first opposite surface 121 abuts against the socket 30, the side of the sleeve 12 close to the socket 30 is the first opposite surface 121, and the side of the plug body 21 close to the socket 30 is the second opposite surface 212. When the sleeve 12 is made of a rigid material, the distance between the first opposite surface 121 and the second opposite surface 212 in the plugging direction of the plug 20 may be naturally 0 (e.g., the first opposite surface 121 may be flush with the second opposite surface 212 to ensure that the first opposite surface 121 can abut against the socket 30 when the plug 20 is plugged into the socket 30). When the sleeve 12 is made of an elastic material, the distance between the first opposite surface 121 and the second opposite surface 212 in the plugging direction of the plug 20 may be greater than 0 mm and less than or equal to 10 mm to ensure that the sleeve 12 has enough space to produce enough deformation.

In a second aspect, as shown in FIG. 4, the examples of the present application provide a plug 20 assembly, comprising a plug 20 and the anti-drop device 10 as described above. The plug 20 includes a plug body 21 and pins 22 arranged at one end of the plug body 21. The anti-drop device 10 can be at least sleeved on a peripheral surface of the end of the plug body 21 close to the pins 22.

Based on the above examples, after the plug 20 is plugged into the socket 30, the plug 20 and the anti-drop device 10 are regarded as a whole. The anti-drop device 10 can increase the torque produced by the frictional force between the plug 20 and the socket 30, thereby reducing the probability of drop of the plug 20 from the socket 30 and strengthening the stability of connection between the plug 20 and the socket 30.

With reference to FIG. 4, in some examples of the present application, the end of the plug body 21 close to the pins 22 has a first limiting structure 211, and the inner surface of the anti-drop device 10 has a second limiting structure 16. After the anti-drop device 10 is sleeved on the plug body 21, the first limiting structure 211 and the second limiting structure 16 limit each other, so that the anti-drop device 10 is in interference fit with the plug body 21, and the anti-drop device 10 can only be detached from the plug body 21 in the plugging direction of the plug 20.

With reference to FIG. 4, in some examples of the present application, the first limiting structure 211 is a ring-shaped first limiting surface, the radial size of the first limiting surface gradually decreases in the plugging direction of the plug 20, the second limiting structure 16 is a ring-shaped second limiting surface, the cavity wall of the second limiting surface gradually decreases in the plugging direction of the plug 20 (e.g., the radial sizes of the ends of the first limiting surface and the second limiting surface close to the socket 30 are smaller than that away from the socket 30, and the first limiting surface fits the second limiting surface when the plug 20 is plugged into the socket 30).

In other examples of the present application, the first limiting structure 211 is a guide rail that protrudes from a peripheral wall of the plug body 21, and the second limiting structure 16 is a guide groove corresponding to the guide rail and formed on the anti-drop device 10. When the anti-drop device 10 is an elastic sleeve, the guide groove is formed on the elastic sleeve and is in communication with the inner cavity of the elastic sleeve. When the anti-drop device 10 includes a sleeve 12 and a suction device 13, the guide groove is formed on the sleeve 12 and is in communication with the inner cavity of the sleeve 12. In some examples of the present application, the axes of the guide groove and the guide rail are parallel to the plugging direction of the plug 20.

The same or similar reference numerals in the accompanying drawings of the examples correspond to the same or similar components. In the description of the present application, it should be understood that if the terms such as “up”, “down”, “left”, and “right” indicate orientations or positional relationships based on the orientations or positional relationships shown in the accompanying drawings, the terms are only for the convenience of describing the present application and simplifying the description, and do not indicate or imply that the device or component referred to must have a specific orientation or be constructed and operated in a specific orientation. Therefore, the terms for describing the positional relationships in the accompanying drawings are only for illustrative description and cannot be understood as limitations of this patent. Those of ordinary skill in the art can understand the specific meanings of the above terms according to specific situations.

Described above are merely the preferred examples of the present application, which are not used for limiting the present application. Any modification, equivalent replacement and improvement, and the like made within the spirit and principle of the present application shall fall within the protection scope of the present application.

What is claimed is:

1. A plug assembly, comprising:
a plug comprising a plug body and pins arranged at one end of the plug body; and
a suction cup sleeved on a peripheral surface of the end of the plug body.

2. The plug assembly according to claim 1, wherein the suction cup is configured to abut against a socket when the plug is plugged into the socket.

3. The plug assembly according to claim 2, wherein:
the suction cup has a first surface opposite to the socket,
the plug has a second surface opposite to the socket, and
a distance between the first surface and the second surface in a plugging direction of the plug is greater than or equal to 0 mm and less than or equal to 10 mm.

4. The plug assembly according to claim 1, wherein the suction cup comprises a suction cavity.

5. The plug assembly according to claim 2, wherein when the plug is plugged into the socket, the suction cup is configured to abut against the socket in a negative pressure suction manner.

6. The plug assembly according to claim 1, wherein the suction cup is a magnetic suction cup.

7. A plug assembly, comprising:
a plug comprising a plug body and pins arranged at one end of the plug body;
an elastic sleeve on a peripheral surface of the end of the plug body, wherein the elastic sleeve comprises a plurality of suction grooves; and
a suction device.

8. The plug assembly according to claim 7, wherein the elastic sleeve is configured to abut against a socket when the plug is plugged into the socket.

9. The plug assembly according to claim 8, wherein the elastic sleeve comprises a receiving groove and the suction device partially arranged in the receiving groove.

10. The plug assembly according to claim 9, wherein the suction device is configured to deform and at least partially retract into the receiving groove when being sucked to the socket.

11. The plug assembly according to claim 8, further comprising a plurality of suction devices distributed along a circumference of the elastic sleeve.

12. The plug assembly according to claim 8, wherein the elastic sleeve comprises:
a hard shell arranged in a ring shape; and
an elastic lining arranged inside the hard shell in a ring shape and sleeved on the peripheral surface of the end of the plug body close to the pins.

13. A system comprising:
a plug comprising a plug body and pins arranged at one end of the plug body;
a socket; and
a device sleeved on a peripheral surface of the end of the plug body and configured to attach to the socket in response to the plug being plugged into the socket.

14. The system according to claim 13, wherein the device comprises a suction cup.

15. The system according to claim 14, wherein the device comprises a sleeve spaced apart from the suction cup.

16. The system according to claim 14, wherein the suction cup is made of elastic material.

17. The system according to claim 15, wherein the sleeve comprises a plurality of suction grooves.

18. The system according to claim 15, wherein the device comprises a plurality of suction devices distributed along a circumference of the sleeve.

19. The system according to claim 13, wherein the device comprises:
a hard shell arranged in a ring shape; and
an elastic lining arranged inside the hard shell in a ring shape and sleeved on the peripheral surface of the end of the plug body close to the pins.

20. The system according to claim 15, wherein the sleeve is made of rubber or silicon.
